(19) United States
(12) Patent Application Publication
(10) Pub. No.: US 2011/0313939 A1
(43) Pub. Date: Dec. 22, 2011

(54) Landlord login

(76) Inventor: Edward C. Eimer, Wenonah, NJ (US)

(21) Appl. No.: 12/932,791

(22) Filed: Mar. 7, 2011

Related U.S. Application Data
(60) Provisional application No. 61/311,770, filed on Mar. 9, 2010.

(51) Int. Cl. G06Q 50/00

(52) U.S. Cl. 705/314

(57) ABSTRACT

The new aspect of Landlord Login is the unique combination of data file types, organizational strategies, secure access and transmission capabilities offered by the process. By using a unique combination of file types, technologies and securities; the Inventor has created a unique process specifically targeted at problems inherent to the real estate leasing and sale process.

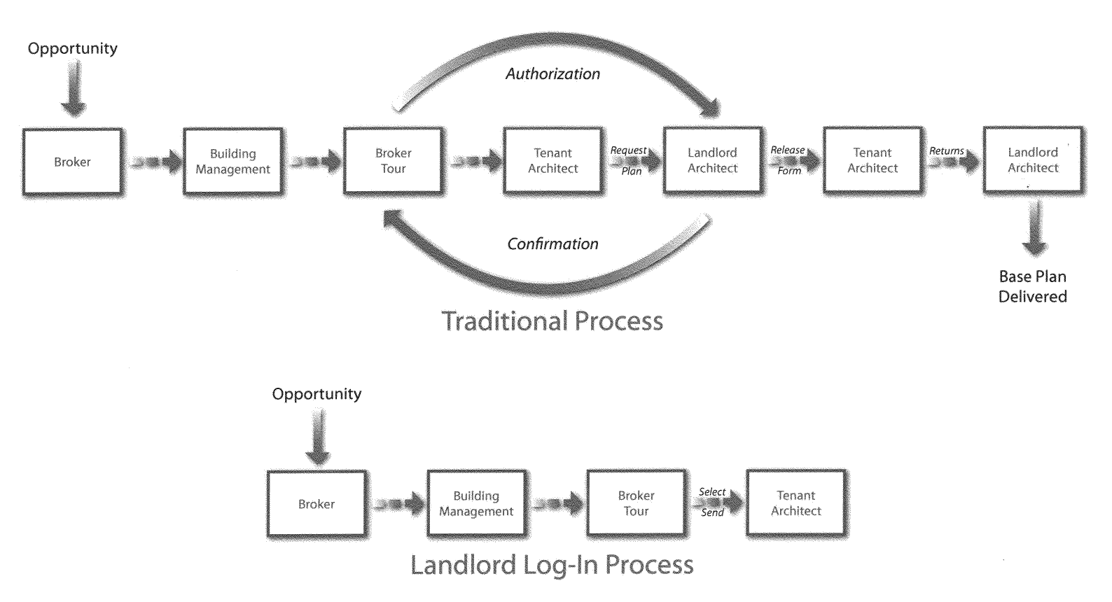

Landlord Login is the process of cataloging, maintaining and sharing building information [primarily floor plans] in a secure and redundant environment using web-based portal access.

The process allows a user to access building floor plans, test fit studies, stacking plans and calculations in digital drawing [AutoCAD] and “PDF” [Adobe Acrobat] format from through any internet connection at any time.

Users link to a website and log in to the process with a secure username and password. Each unique username and password allows access to their specific information only. Users navigate separate tabs to access specific categories of information: existing conditions, test fit studies, stacking plans and calculations.

All floor plans are neatly organized and produced in both “DWG” [AutoCAD] and “PDF” [Adobe Acrobat] format. All other documents are organized in “PDF” format.

Users can use the process to view, download or email documents directly from the website.

The Inventor creates each document and uploads each to a secure server, and then the Inventor creates a website link for each building. Links to each existing conditions floor plan, test fit study, stacking plan and calculation are created which allow users to view, download or email the documents.

The Inventor creates and issues unique usernames and passwords for each user, and then the Inventor creates a main web page with secure log-in access. Each unique username and password allows access to specific building information, providing informational security for each user's data. If a user feels that their username or password may have been compromised, the Inventor can re-issue new usernames and passwords instantly.

### DESCRIPTION OF THE DIAGRAM

The upper diagram illustrates a traditional tenant real estate evaluation process. The process begins when a prospective tenant looking for office space contacts a landlord broker. The broker then discusses the opportunity with building management, determines the spaces which may best fit the prospective tenant's needs. The broker then schedules a tour of the spaces and together they determine which space best fits their needs so a design plan can be started. After determining the space, the prospective tenant's architect is the next key professional in the process; and is responsible for creating the design plan from which the entire real estate transaction will be based on. Until the prospective tenant's architect has the landlord's existing conditions plan of the space that provides the best fit, the real estate transaction cannot move forward. To simply obtain that existing conditions file, the tenant's architect must wait for six more processes to complete. They are: 1) the brokers contact the tenant's architect and inform them of which space has been selected for the design; 2) the tenant's architect contacts the landlord's architect and requests the existing conditions plan; 3) the landlord's architect confirms with the landlord's broker that the file and space are correct and that they are authorized to release them; 4) the landlord's architect sends a release waiver to the tenant's architect stating that the tenant's architect is responsible for confirming the accuracy of the existing file; 5) the tenant's architect signs the waiver and returns it to the landlord's architect; 6) the landlord's architect delivers the existing conditions plan to the tenant's architect. This process can take up to 2 weeks to complete, adding time and risk to the potential real estate transaction.

The lower diagram illustrates how Landlord Login expedites this slow sequence of processes by giving the landlord's broker the ability to send the existing conditions drawing from anywhere there is an internet connection—even from their smart phone during the tour of spaces available in the building. The first three steps in the process are exactly identical to the traditional process; but Landlord Login eliminates the final six processes. By giving the landlord's broker the ability to search, select and send the file to the tenant's architect the entire process is streamlined, eliminating time and risk to the real estate transaction.

1. The specific inventions of Landlord Login is the unique combination of data file types, organizing and secure access that, in combination, create a unique process specifically targeted for the real estate community.
On their own, the use of data file types, organizational discipline and web-based access to information is not unique. But the strategic combination of each develops a process designed to facilitate access and transmission offers users the benefits of instant recognition and secure access; combined with the ability to instantly view, download and transmit critical documents in a completely unique way.
It is the combination of these elements [file types, organization strategy, web-based access and view/download/transmission ability] that creates the unique process worthy of patent protection.
Patent protection will allow the Inventor to capitalize on realization that the combination of elements to create a process offers unique solutions to the real estate community. This process serves the need all real estate professionals have for instant access to accurate data, and the ability to transmit this data without reliance on third parties.
